(19) United States
(12) Patent Application Publication
(10) Pub. No.: US 2026/0364912 A1
(43) Pub. Date: Nov. 19, 2026

(54) METHOD AND SYSTEM FOR FORMING ARTICLES

(71) Applicant: Graphic Packaging International, LLC, Atlanta, GA (US)

(72) Inventors: William Gilpatrick, Broomfield, CO (US); Jeffrey T. Sloat, Broomfield, CO (US); Eric Bohn, Marathon, WI (US); Chris Baker, Thornton, CO (US)

(21) Appl. No.: 19/755,052

(22) Filed: Jul. 27, 2026

Related U.S. Application Data
(63) Continuation-in-part of application No. 19/048,033, filed on Feb. 7, 2025.
(60) Provisional application No. 63/551,618, filed on Feb. 9, 2024.
(60) Provisional application No. 63/852,244, filed on Jul. 28, 2025.

(51) Int. Cl. B31B 50/59

(52) U.S. Cl. CPC B31B 50/59

(57) ABSTRACT

A method and system for press-forming a construct. The method can comprise obtaining a forming tool comprising at least a punch and a cavity part. The cavity part at least partially defines a cavity and comprises a plurality of ports in fluid communication with the cavity. The method further includes positioning a moisturized paperboard packaging material between the punch and the cavity, and press-forming the moisturized paperboard packaging material into the construct by moving the punch and the cavity part together so that the punch is at least partially received in the cavity with the moisturized paperboard packaging material pressed therebetween. The method also includes removing moisturizing fluid in the cavity released by the moisturized paperboard packaging material during press-forming via the plurality of ports in the cavity part.

### CROSS-REFERENCE TO RELATED APPLICATIONS

This application is a Continuation-In-Part (CIP) application of U.S. patent application Ser. No. 19/048,033, which was filed on Feb. 7, 2025, which claims the benefit of U.S. Provisional Patent Application No. 63/551,618, which was filed on Feb. 9, 2024. This application claims the benefit of U.S. Provisional Patent Application No. 63/852,244 which was filed Jul. 28, 2025.

### INCORPORATION BY REFERENCE

The disclosures of U.S. patent application Ser. No. 19/048,033, which was filed on Feb. 7, 2025, U.S. Provisional Patent Application No. 63/551,618, which was filed on Feb. 9, 2024, and U.S. Provisional Patent Application No. 63/852,244, which was filed Jul. 28, 2025, are hereby incorporated by reference for all purposes as if presented herein in their entirety.

### TECHNICAL FIELD

The present disclosure generally relates to packaging materials and systems and methods for making packaging materials and/or for making articles from packaging materials. For example, the packaging material can include paperboard or other suitable materials and the systems and methods can include moistening the packaging material and forming the packaging material into containers and/or other suitable articles.

### BACKGROUND OF THE DISCLOSURE

Containers such as trays, bowls, etc. fold holding food products and/or other items can include features such as multiple compartments (e.g., having compartments of similar and/or different sizes and/or shapes), deep draws (e.g., bowl depths of greater than 2.5 inches (63.5 mm)), stiffening features (e.g., ribs), and/or other suitable features. Such containers may be made from molded plastic, for example. However, there is a desire to reduce or eliminate plastic in packaging in favor of more renewable and/or recyclable materials. For example, paper products (e.g., with a plastic barrier layer) can be used in packaging to significantly reduce the amount of plastic in the package or uncoated paperboard could be used to further reduce or eliminate the plastic from the packaging. Paper-based containers with features such as multiple compartments, deep draws, stiffening features, etc. can be made by molding a pulp into the shape of the container in examples. However, molded pulp processes tend to be expensive and slow.

### SUMMARY OF THE DISCLOSURE

In general, one aspect of the disclosure is directed to a method of press-forming a construct. The method can comprise obtaining a forming tool comprising at least a punch and a cavity part. The cavity part at least partially defines a cavity and comprises a plurality of ports in fluid communication with the cavity. The method further includes positioning a moisturized paperboard packaging material between the punch and the cavity, and press-forming the moisturized paperboard packaging material into the construct by moving the punch and the cavity part together so that the punch is at least partially received in the cavity with the moisturized paperboard packaging material pressed therebetween. The method also includes removing moisturizing fluid in the cavity released by the moisturized paperboard packaging material during press-forming via the plurality of ports in the cavity part.

In another aspect, the disclosure is generally directed to a forming tool for press-forming a construct. The forming tool can comprise a punch and a cavity part. The cavity part at least partially defines a cavity and comprises a plurality of ports in fluid communication with the cavity. The punch is for being at least partially received in the cavity for press-forming a moisturized paperboard packaging material into the construct between the punch and an interior surface of the cavity. The plurality of ports is for removing moisturizing fluid in the cavity released by the moisturized paperboard packaging material during press-forming.

In another aspect the disclosure is generally directed to a method of treating a paper-based packaging material. The method can comprise applying a moisturizing liquid to the packaging material to form a moisturized packaging material. The moisturizing liquid can include one or more surfactants. The method further can comprise forming the moisturized packaging material into a construct. In some embodiments, the moisturized packaging material can contain more than 20 weight percent of moisturizing liquid prior to the forming the moisturized packaging material.

In another aspect, the disclosure is generally directed to a method of press-forming a construct. The method comprises obtaining a forming tool comprising at least a punch and a cavity part, wherein the cavity part at least partially defines a cavity and comprises a plurality of ports in fluid communication with the cavity, obtaining an initial paperboard packaging material, the initial paperboard packing material is a finished and manufactured solid bleach sulfate paperboard material, feeding the initial paperboard packaging material to a treatment station and moisturizing the initial paperboard packaging material to form a moisturized paperboard packaging material by applying a moisturizing liquid with a surfactant to the initial paperboard packaging material, positioning the moisturized paperboard packaging material between the punch and the cavity, press-forming the moisturized paperboard packaging material into the construct by moving the punch and the cavity part together so that the punch is at least partially received in the cavity with the moisturized paperboard packaging material pressed therebetween, and removing moisturizing fluid in the cavity released by the moisturized paperboard packaging material during press-forming via the plurality of ports in the cavity part.

In another aspect, the disclosure is generally directed to a system for press-forming a construct. The system comprising a treatment station for moisturizing an initial paperboard packaging material, the initial paperboard packaging material is a finished and manufactured solid bleached sulfate paperboard material. The treatment station includes a moisturizing liquid with a surfactant and is for forming a moisturized paperboard packaging material by adding the moisturizing liquid with the surfactant to the initial paperboard packaging material. The system includes a forming tool comprising at least a punch and a cavity part, wherein the cavity part at least partially defines a cavity and comprises a plurality of ports in fluid communication with the cavity. The punch is for being at least partially received in the cavity for press-forming the moisturized paperboard packaging material into the construct between the punch and an interior surface of the cavity, and wherein the plurality of ports are for removing moisturizing fluid in the cavity released by the moisturized paperboard packaging material during press-forming.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure. The drawings are schematic and exemplary only and should not be construed as limiting the invention.

FIG. 1 is a schematic view of a system for forming a container or other suitable construct according to exemplary embodiments of the disclosure.

FIG. 2 is a schematic view of a packaging material treatment station of the system of FIG. 1 according to exemplary embodiments of the disclosure.

FIGS. 3A and 3B are schematic view of respective forming tools of a forming station of the system of FIG. 1 according to exemplary embodiments of the disclosure.

FIGS. 4A and 4B are schematic cross-sectional views of portions of respective packaging materials according to exemplary embodiments of the disclosure.

FIGS. 5 and 6 are perspective views of an exemplary forming tool according to exemplary embodiments of the disclosure.

FIG. 7 is a top plan view of a bottom assembly of the forming tool of FIGS. 5 and 6.

FIG. 8 is a cross-sectional view of the bottom assembly of FIG. 7 taken along line A-A.

FIG. 9 is a bottom perspective view of a cavity of the bottom assembly of FIGS. 7 and 8.

FIGS. 10A and 10B are perspective views of a bottom plate of the bottom assembly of FIGS. 7 and 8.

FIGS. 11A and 11B are top plan views of respective cavity inserts that can cooperate with the cavity of the bottom assembly according to exemplary embodiments of the disclosure.

FIG. 12 is a perspective view showing a cavity insert separated from the cavity according to exemplary embodiments of the disclosure.

FIG. 13 is an exemplary chart showing the moisture gain by weight percent in a paperboard packaging material moisturized with water containing different amounts of a surfactant compared to water with no surfactants over different dwell times according to exemplary embodiments of the disclosure.

FIG. 13A is an exemplary chart showing the moisture gain by weight percent in a paperboard packaging material moisturized with water containing 0.05% by weight of a surfactant over different dwell times according to exemplary embodiments of the disclosure.

FIGS. 14A-16B are schematic views of a tooling for forming a construct from highly moisturized paperboard packaging material according to exemplary embodiments of the disclosure.

Corresponding parts are designated by corresponding reference numbers throughout the drawings.

### DETAILED DESCRIPTION OF THE EXEMPLARY EMBODIMENTS

In embodiments the present disclosure provides systems and methods of forming a packaging material (e.g., in the form of a web or a blank) into a tray, carton, and/or other suitable container or construct for holding and/or packaging one or more articles. In exemplary embodiments, the packaging material can be formed into a construct for use in storing, transporting, displaying for sale, heating, eating, etc. one or more food items. The packaging material can comprise fibrous materials such as paper-based materials including paperboard (e.g., solid bleached sulfate paperboard), which can be uncoated or can be coated (e.g., with a barrier layer such as a polymer film or other suitable coating and/or laminated material). As described herein

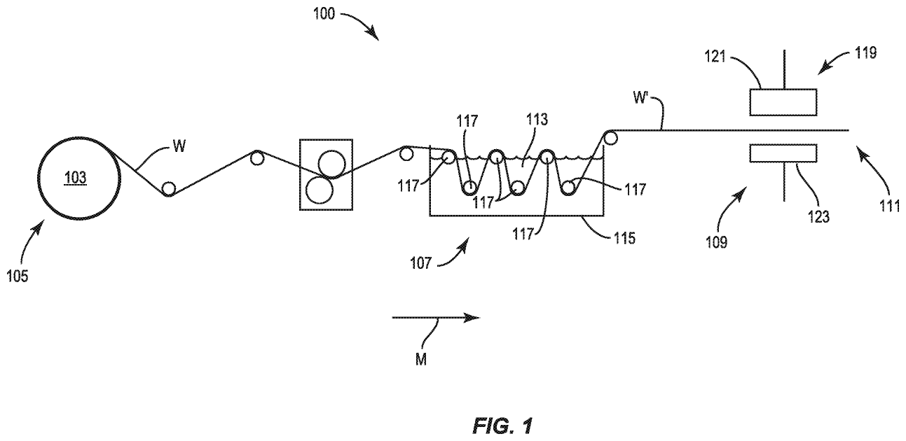

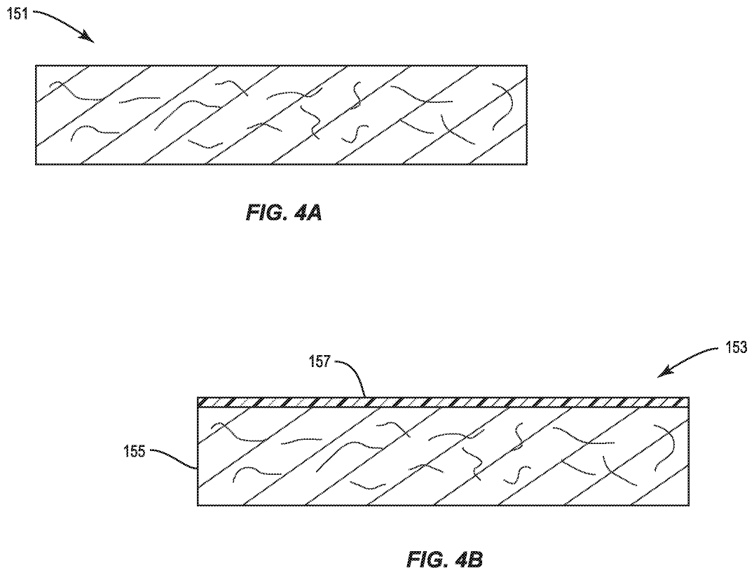

As schematically shown in FIG. 1, the method and system 100 can include feeding an initial packaging material, such as in the form of a web of initial packaging material W, in a downstream or machine direction M from a roll 103 at an upstream end 105 to a treatment station 107, then to a forming station 109, and to an output or downstream end 111. In embodiments, the system 100 can include a web transport system, which can include a plurality of drive rollers, guide rollers, nip rollers, and/or other suitable features for moving the web of material W through the system 100. In other embodiments, the initial packaging material can be in the form of a plurality of blanks (not shown) that can be fed from the upstream end 105 (e.g., from a belt feeder or pick-and-place feeder and/or a conveyor or other suitable feeding and/or transport system). In exemplary embodiments, the initial packaging material (e.g., in the form of a web, a blank, and/or another suitable material) can be uncoated paperboard 151 (e.g., as schematically shown in cross-section in FIG. 4A) or can be a material 153 with a paperboard or other suitable substrate or base layer 155 and a barrier layer 157 on a face of the paperboard substrate 155 (e.g., as schematically shown in cross-section in FIG. 4B). In embodiments, the barrier layer 157 can be a coating or laminated layer, such as a polymer (e.g., PET) or other suitable material.

In various embodiments of the disclosure, the web of material W or initial packaging material can include paperboard 151, 153, 155 that is a finished and manufactured paperboard packaging material that is an initial paperboard packaging material that is modified by the various methods, processes, systems, and apparatus of the present disclosure. For example, the initial paperboard packaging material 151, 153 155 that is a fully finished, formed, and manufactured paperboard material is paperboard that is a multi-ply structure made from several distinct layers of fiber pressed together, dried, and subject to a finishing process which can include the application of a clay coating to create a smooth, high gloss surface for crisp printing, and a smoothing/calendaring process that compacts the material to ensure uniform thickness of the finished paperboard. During the manufacturing of the finished paperboard product, water is combined with fibers such as wood chips or recycled papers at various stages of the manufacturing process prior to the finishing/drying process that results in the finished paperboard material. The finished paperboard product is used as the initial paperboard in the various forming processes and systems described herein. That is, the processes of the present disclosure relate to various forming steps that manipulate the finished paperboard product so as to enhance the formability of the finished paperboard product.

The initial paperboard packaging material 151, 153, 155 can be coated or uncoated and can be of a caliper that is heavier and more rigid than ordinary papers. For example, the initial paperboard packaging material 151, 153, 155 can be referred to as folding carton board and having sufficient strength and rigidity to be suitable for forming cartons, constructs, or other packaging. A common initial paperboard packaging material can be a Solid Bleached Sulfate (SBS) paperboard also referred to as bleached paperboard that is made from virgin wood fibers. Solid Bleached Sulfate (SBS) paperboard is available from Graphic Packaging International, LLC under various trade names including EVEREST folding carton board, FORTRESS folding carton board, or any other suitable trade name. Further, suitable initial paperboard packaging material is also available from any other suitable manufacturer without departing from this disclosure.

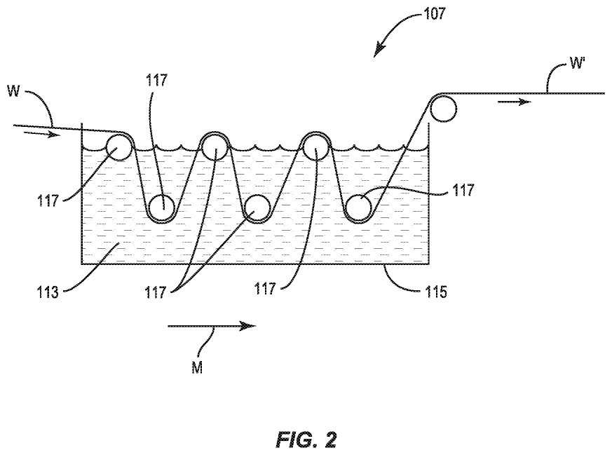

As shown in FIGS. 1 and 2, the treatment station 107 (e.g., an inline moistening unit/apparatus) can include a moisturizing liquid 113 in a vessel/tank 115. In embodiments, the moisturizing liquid 113 can be water or a water-based solution or mixture (e.g., water with surfactants and/or other materials) or another suitable moisturizing material (e.g., including water and/or other suitable liquids, solutes, mixtures, substances in suspension, etc.). In the illustrated embodiments, the web of material W can move over a plurality of rollers 117 (e.g., guide rollers and/or drive rollers) through the treatment station 107. As shown in FIGS. 1 and 2, the rollers 117 can be positioned so that each roller 117 is offset in the machine direction M and in the vertical direction from the previous roller 117 for moving the web of material W into and out of the moisturizing liquid 113 as the web of material W is moved through the treatment station 107. In other embodiments, the upper rollers 117 can be positioned in the moisturizing liquid 113 so that the web of material W remains in the moisturizing liquid 113 as the web of material W is moved through the moisturizing station 107. In exemplary embodiments, the length of the vessel 115, the number and positioning of the rollers 117, the depth of the moisturizing liquid 113 in the vessel 115, and/or other suitable parameters can be selected for achieving a desired dwell time of the web of material W for a particular processing speed of the system 100. In embodiments, increasing the dwell time of the web of material W in the moisturizing liquid 113 can increase the amount of the moisturizing liquid 113 absorbed by the web of material W and decreasing the dwell time can decrease the amount of moisturizing liquid 113 absorbed by the web of material W. Other parameters may affect the amount of moisture that is absorbed by the web of material W, such as the temperature of the moisturizing liquid 113 and/or the use of surfactants. For example, heat can be applied to the moisturizing liquid and/or surfactants can be included in the moisturizing liquid to increase water penetration into the material.

In embodiments in which the initial packaging material is in the form of a plurality of blanks (not shown), the blanks can be moved to the treatment station (e.g., on a conveyor or with a pick-and-place apparatus). One or more blanks can be positioned in the moisturizing liquid 113 for a predetermined dwell time. Subsequently, the blanks can be removed from the moisturizing liquid 113 and conveyed to the forming station 109. In alternative embodiments, one or more blanks can be moved through the moisturizing liquid 113, such as by a conveyor. The treatment station 107, including at least the moisturizing liquid 113, the vessel 115, and/or the rollers 117, could be otherwise shaped, arranged, positioned, and/or configured without departing from the disclosure.

In exemplary embodiments, the treatment station 107 can be configured to form an intermediate or treated packaging material, such as an intermediate or treated web W′ (e.g., a moisturized web) (FIG. 1) or a moisturized blank (not shown) with a predetermined moisture content (e.g., moisture absorbed by the fibers of the material). In embodiments, the material can be moisturized to a sufficient moisture content so that the treated packaging material can be press-formed into desired shape(s) while avoiding oversaturating the material (e.g., wherein one or more properties of the material degrade below a desired level, such as by failing a tensile test or by breaking apart in the moisturizing liquid 113). For example, the treated web W′ can include more than 10% by weight of the moisturizing liquid 113, between about 10% and about 50% by weight of the moisturizing liquid 113, between about 10% and about 20% by weight of the moisturizing liquid 113, between about 20% and about 30% by weight of the moisturizing liquid 113, between about 30% and about 40% by weight of the moisturizing liquid 113, between about 40% and about 50% by weight of the moisturizing liquid 113, between about 20% and about 50% by weight of the moisturizing liquid 113, between about 30% and about 50% by weight of the moisturizing liquid 113, between about 10% and about 40% by weight of the moisturizing liquid 113, between about 10% and about 30% by weight of the moisturizing liquid 113, between about 20% and about 40% by weight of the moisturizing liquid 113, and/or other suitable moisture contents.

As schematically shown in FIG. 1, the treated web W′ can move in the machine direction M from an output of the treatment station 107 to the forming station 109 (e.g., over rollers and/or other suitable conveying features). In other embodiments, the moisturized blank (not shown) can be conveyed from the treatment station 107 to the forming station 109. In embodiments, the forming station 109 can include a forming tool 119, such as a metal press-forming tool or other suitable tool. In exemplary embodiments, the forming tool 119 can be configured for forming a suitable construct, such as a tray (e.g., a tray having multiple compartments, straight sides, and/or curved corners), a bowl (e.g., a container with a deep draw, such as a bowl with a depth of greater than 2.5 inches (63.5 mm)), a container with stiffening features (e.g., ribs or other suitable features), and/or other suitable constructs. For example, the forming tool 119 can include a first (e.g., upper) part 121 and a second (e.g., lower) part 123 with corresponding features that can be pressed together to form the treated web of material W′ or the moisturized blank into the construct. In exemplary embodiments, the first part 121 and the second part 123 can include projections, protrusions, recesses, cavities, etc. that are complementary with respective cavities, recesses, protrusions, projections, etc. in the opposing tool part.

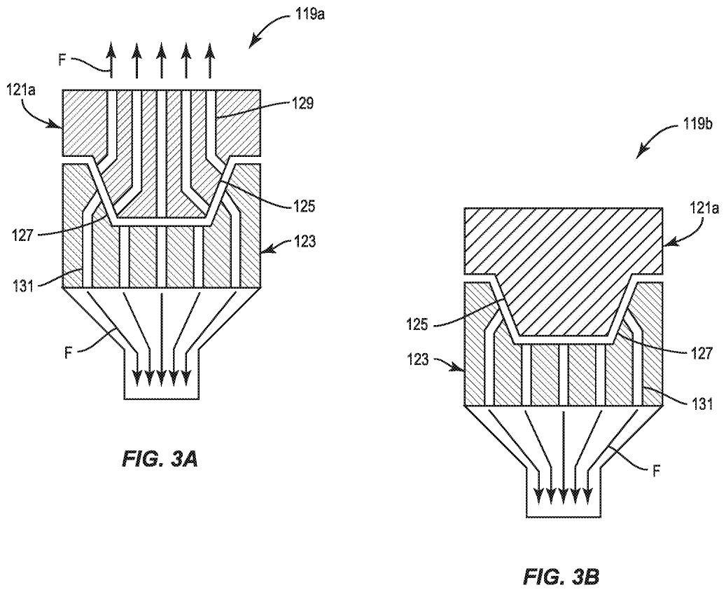

In an exemplary embodiment schematically shown in FIG. 3A, a forming tool 119a can be configured for press-forming a treated web of material W′ and/or a treated blank that does not include a barrier layer on either surface (e.g., uncoated paperboard 151 shown schematically in FIG. 4A). In the illustrated embodiments, the forming tool 119a includes a first part 121a with a projection 125 and a second part 123 with a cavity 127, wherein the cavity 127 and the projection 125 cooperate to press-form the uncoated treated web of material W′ and/or moisturized blank into a container (not shown). The cavity 127 and the projection 125 shown, schematically, in FIG. 3A are included by example only, and the first part 121a and the second part 123 could have any suitable forming features for forming any suitable construct.

As schematically shown in FIG. 3A, a plurality of ports 129 (e.g., first or upper ports 129) are formed in the first part 121a and a plurality of ports 131 (e.g., second or lower ports 131) are formed in the second part 123. In embodiments, the forming tool 119a can include any suitable number of ports 129, 131 (e.g., one or more ports). In the illustrated embodiments, the ports 129, 131 can provide pathways through the respective parts 121a, 123 of the forming tool 119a for communicating steam and/or other fluid(s) F at least partially through the respective parts 121a, 123. For example, the forming surfaces of the parts 121a, 123 (e.g., the surfaces that face, contact, and/or press against the treated web W′ and/or the treated blank) can be in fluid communication with a respective exhaust feature of the respective part 121a, 123. In embodiments, moisture and/or other fluids F from the moistened material (e.g., steam and/or other vapor formed from the moisturizing liquid due to the heat and/or pressure applied by the forming tool 119a) can be ventilated from the portion of the forming tool 119a between the parts 121a, 123 to respective exhaust features via the ports 129, 131. In embodiments, the ports 129, 131 can allow the fluids F to escape passively and/or vacuum pressure can be applied via the ports 129, 131 to draw the moisture through the ports 129, 131 away from the press-formed material.

In embodiments in which the treated web of material W′ or treated blank includes a barrier layer on one surface (e.g., initial paperboard packaging material 153 with the finished and manufactured paperboard base layer 155 and the barrier layer 157), the ports in the part of the forming tool facing the barrier layer can be omitted. For example, as schematically shown in FIG. 3B, the forming tool 119b includes a first part 121b that does not have the ports 129. The forming tools 119a, 119b, including the parts 121a, 123, 121b could be otherwise shaped, arranged, positioned, and/or configured without departing from the disclosure. For example, the forming tools 119a, 119b could include any suitable forming features and/or any suitable number of ports 129, 131.

In the illustrated embodiments, the containers or other constructs formed in the forming station 109 can exit the forming station 109 and continue in the machine direction M for further processing (e.g., application of additional coatings and/or other treatments, lamination, etc.), covering, (e.g., application of a lid, film, overwrap, etc.), and/or other suitable operations. Accordingly, the treatment station 107 and the forming station 109 can be in line with other stations for finishing the construct. Further, in embodiments, the system 100 could include additional stations and/or apparatus and the packaging material and/or intermediate packaging material could undergo additional processing and/or forming operations before the treatment station 107 and/or between the treatment station 107 and the forming station 109.

In embodiments, moisturizing the web of material W and/or the blank to a high moisture content and press-forming the moisturized material with a forming tool having a plurality of ports for ventilating steam and/or other fluids F can have advantages over other embodiments. For example, in some embodiments, the web of material or blank is moisturized (e.g., in a laminator or other suitable device) to less than or equal to 10% moisture concentration to limit or avoid tearing, rupturing, and/or blow outs of the material caused by steam formation during press-forming when the steam has no outlet from the forming tool. Limiting the moisture content to less than 10% can limit the constructs formed from the material to fewer features (e.g., single compartment trays, constructs with two equal compartments, shallow containers, little or no stiffening features) (e.g., due to a relatively low malleability of the material with limited moisture content). In exemplary embodiments, porting the forming tool 119 in the forming station 109 can reduce or eliminate the risk of damage to the pressed material by ventilating and/or evacuating at least a portion of the steam formed from the moisturized material during pressing. Accordingly, the web of material W and/or blank can be moisturized in the treatment station 107 to have a moisture content of over 10%, which can allow the material to be formed into containers and/or other constructs with numerous features (e.g., stiffening features and/or multiple compartments of similar and/or different sizes and/or shapes) and/or with deeper draws (e.g., with depths of more than 2.5 inches (63.5 mm)). For example, the treated web W′ or treated blank with a moisture content of over 10% can be more malleable than materials with less moisture. In exemplary embodiments, the moistened material can be paperboard that may become a malleable “fluff pulp” type of material when moistened to a high moisture content. In embodiments, when moistened as described above, the material (e.g., paperboard) can have the capabilities (e.g., features) of containers and other constructs made from molded plastic or molded pulp with the speed and/or other advantages of paperboard systems that operate with paperboard in the form of webs and/or blanks.

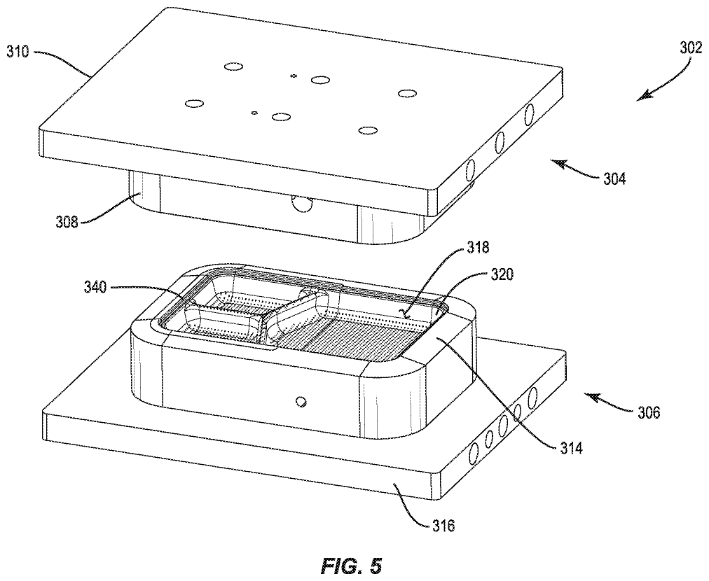

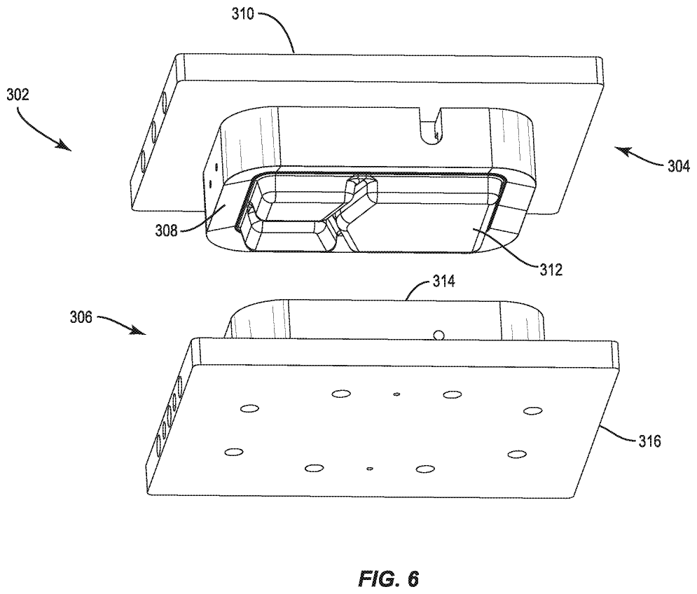

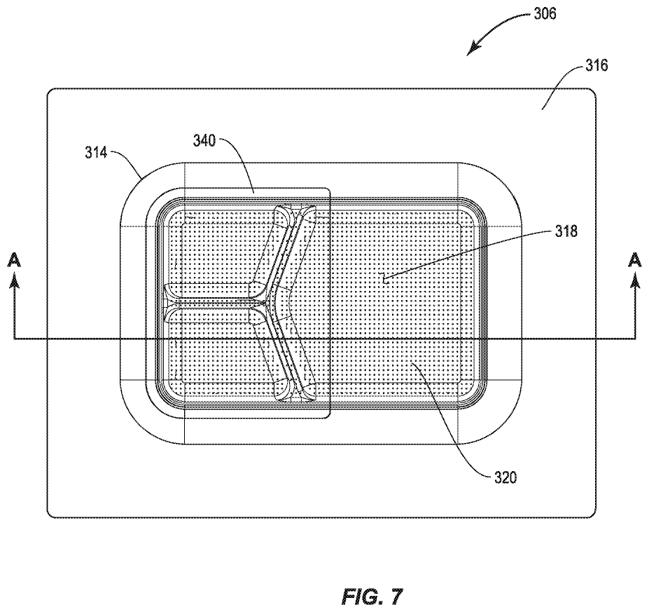

As shown in FIGS. 5 and 6, an exemplary forming tool 302 (e.g., for use in the forming station 109 of FIG. 1) can include a first or top assembly 304 and a second or bottom assembly 306 opposite to the top assembly 304. In the illustrated embodiments, the top assembly 304 can include a draw ring 308 mounted to a top mounting plate 310 and a protrusion or punch 312 at least partially received in an interior space of the draw ring 308. As shown in FIGS. 5 and 6, the bottom assembly 306 can include a cavity part 314 mounted to a bottom mounting plate 316. In embodiments, the cavity part 314 can define a cavity 318 opposite to the bottom mounting plate 316, and the cavity 318 can extend along an interior surface 320 of the cavity part 314 (FIGS. 5, 7, and 8). In the illustrated embodiments, the cavity 318 and the punch 312 can be complementary shapes so that the punch 312 is at least partially received in the cavity 318 when pressing the packaging material into the shape of a corresponding construct. For example, as shown in FIGS. 5 and 6, the punch 312 and the cavity 318 can be shaped to form a construct such as a tray with three compartments. Alternatively, the punch 312 and the cavity 318 can have any suitable shape for forming a construct or container having any suitable shape or feature without departing from the disclosure.

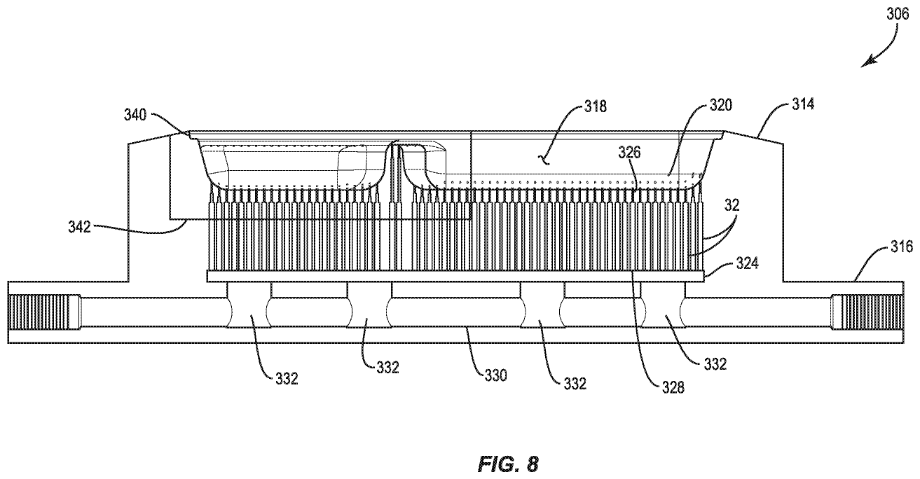

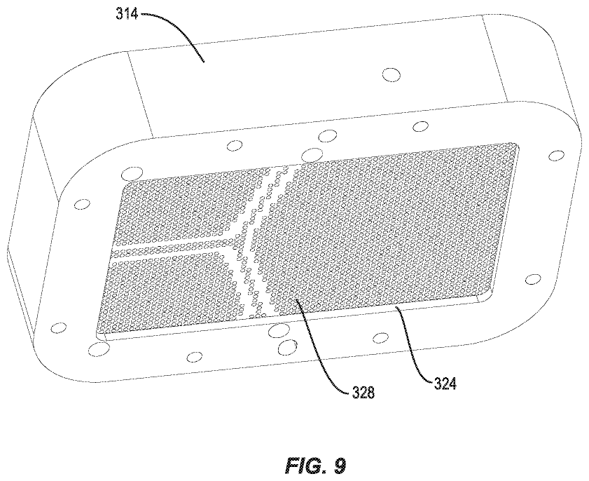

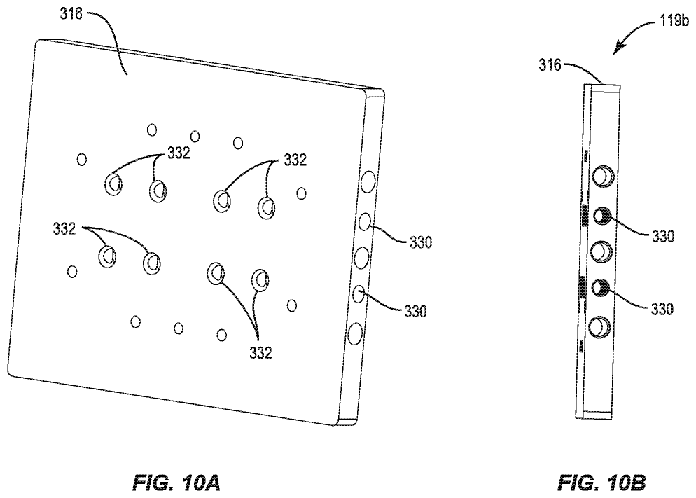

As shown in the cross-sectional view of FIG. 8, the bottom assembly 306 can include exhaust features for facilitating the movement of steam and/or other fluids F from the interior surface 320 of the cavity 318 (e.g., when press-forming a paperboard material with moistened with greater than 10 wt % moisturizing fluid). In exemplary embodiments, a plurality of ports 322 can extend through the cavity part 314 from the interior surface 320 of the cavity 318 to a bottom recess 324 defined in the bottom of the cavity part 314 (FIGS. 8 and 9). In the illustrated embodiments, each of the ports 322 can be in fluid communication with the cavity 318 via an inlet 326 and can be in fluid communication with the bottom recess 324 via an outlet 328. As shown in FIGS. 8, 10A, and 10B, the bottom mounting plate 316 can include two output passageways 330 in fluid communication with the bottom recess 324 of the cavity part 314 via openings 332 (e.g., via four openings 332 for each of the output passageways 330). Alternatively, the bottom mounting plate 316 could include any suitable number of output passageways 330 and any suitable number of openings 332. In embodiments, the ends of the output passageways 330 can be adapted to be coupled to hoses or pipes or other suitable fluid passages for moving the exhaust fluids F to a collection tank, for example. In embodiments, one or more of the ends of the passageways 330 can be connected to a vacuum apparatus (not shown) for aiding in the removal of the exhaust fluids F via the ports 322, the bottom recess 324, the openings 332, and the output passageways 330.

In the illustrated embodiments, the exhaust fluids F can move from the cavity 318 through the ports 322. The exhaust fluids F can move into the bottom recess 324 through the outlets 328 of the ports 322, and then can move into the openings 332 and through the output passageways 330. Accordingly, steam and/or other fluids F released from the moistened paperboard packaging material can be removed from the cavity 318 to help avoid blistering of a coating layer on the top surface of the packaging material, tearing of the packaging material, and/or other negative consequences of having steam and/or other fluids F trapped in the cavity 318 during press forming.

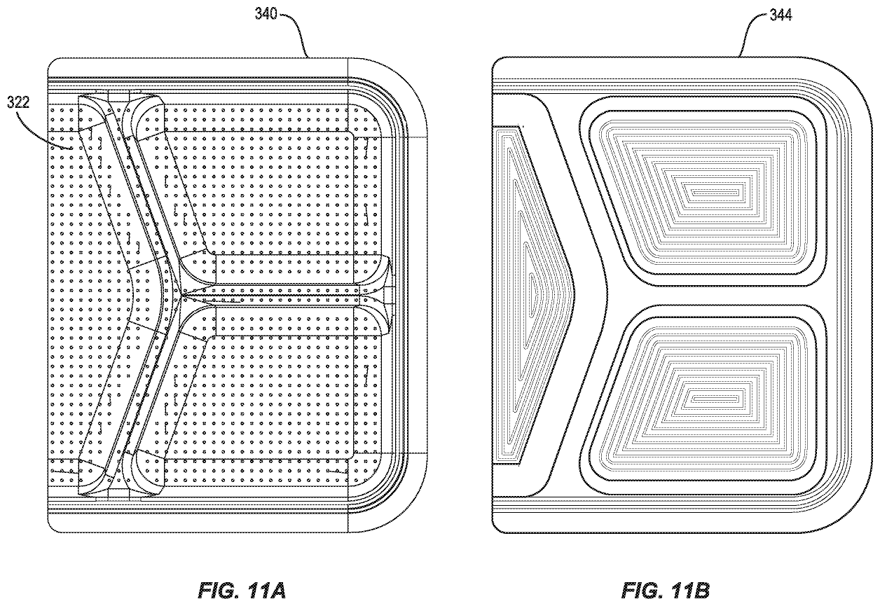

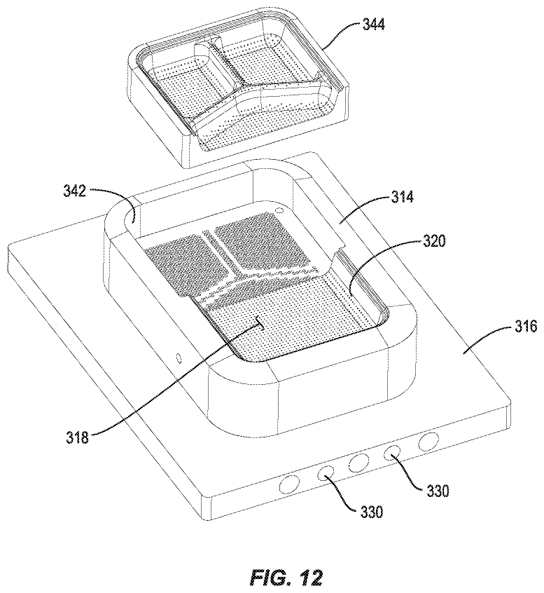

As shown in FIGS. 5, 7, and 8, a portion of the interior surface 320 of the cavity 318 can extend along an insert 340 FIGS. 5, 7, 8, and 11A) received in a pocket 342 (FIG. 12) defined in the cavity part 314. As shown in FIG. 8, the ports 322 aligned with the pocket 342 can continue through the insert 340 so that the portion of the interior surface 320 of the cavity 318 extending along the insert 340 is in fluid communication with the bottom recess 324 via the ports 322. In embodiments, the insert 340 can be replaced by an insert 344 (FIGS. 11B and 12), which does not include the ports 322 so that the portion of the interior surface 320 of the cavity 318 extending along the insert 340 is not in fluid communication with the bottom recess 324.

The forming tool 302 could be otherwise shaped, arranged, and/or configured without departing from the disclosure. For example, while the top assembly 304 lacks exhaust features as shown in FIGS. 5 and 6, an alternative top assembly 304 could include exhaust features such as ports in the punch and output passageways in the top mounting plate 310, which can be similar to the ports 322 and the output passageways 330 in the bottom assembly 306.

In operation, a moisturized paperboard packaging material can be moved between the top assembly 304 and the bottom assembly 306, and the top assembly 304 and the bottom assembly 306 can be moved together (e.g., by moving one or both of the top assembly and the bottom assembly). As the top assembly 304 and the bottom assembly 306 are moved together, the punch 312 can move into the cavity 318, pressing the moisturized paperboard into the cavity 318. The punch 312 and the interior surface 320 of the cavity 318 press-form the moisturized paperboard into the shape of the construct according to the complementary shapes of the punch 312 and the cavity 318. During this press-forming, steam and/or other fluids F can be released from the moisturized paperboard and can be vented out of the cavity 318 via the exhaust features (e.g., the ports 322, the recess 324, the openings 332, and the output passageways 330). Subsequently, the top assembly 304 and the bottom assembly 306 can be separated (e.g., by moving one or both of the top assembly and the bottom assembly), and the press-formed construct (not shown) can be removed from the tool 302.

In exemplary embodiments, the moisturizing liquid 113 can be a water-based liquid incorporating food-grade surfactants that can act as a wetting agent and can amplify and/or accelerate the process of moisturization of the paperboard in embodiments. In examples, the surfactants may be hydroxypropyl cellulose, polysorbate 60, gum arabic, sodium lauryl sulfate (SLS), and/or other suitable materials. Further, the surfactants can be stearates, fatty-acid esters, fatty alcohols, and/or other suitable materials. In exemplary embodiments, the surfactant(s) can be added to a base liquid (e.g., water) in amounts suitable for a particular moisturizing process (e.g., water bath submersion processes, printing-like processes, flexo/gravure coating processes, Mayer rod coating processes, curtain coating processes, die coating processes, and/or other suitable moisturizing processes) and to achieve a desired moisturization of the paperboard with desired process parameters (e.g., dwell time, processing speed, moisturization levels, etc.). The moisturizing system can be in line with one or more other stations (e.g., cutting, forming, filling, lidding, etc. stations) in a packaging system and/or could be a separate system. In embodiments, the surfactant(s) can facilitate an increased water uptake and moisturization of the initial paperboard material 151, 153, 155, such as by lowering the surface tension of the base liquid (e.g., water) of the moisturizing liquid 113. For example, while other moisturization processes (e.g., plain water not utilizing surfactants) may moisturize the paperboard to about 7% to about 10% by weight, the uptake of the moisturizing liquid including one or more surfactants into the paperboard can result in a treated material/treated web W′ having about 20% by weight or more of moisturizing liquid in the paperboard, depending on system and/or processing parameters (e.g., dwell time, surfactant(s) used, surfactant concentration, processing speed, etc.).

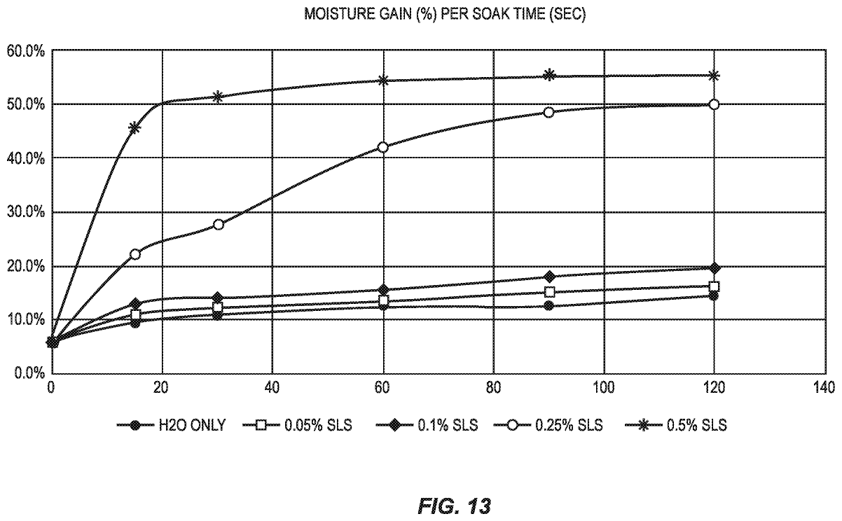

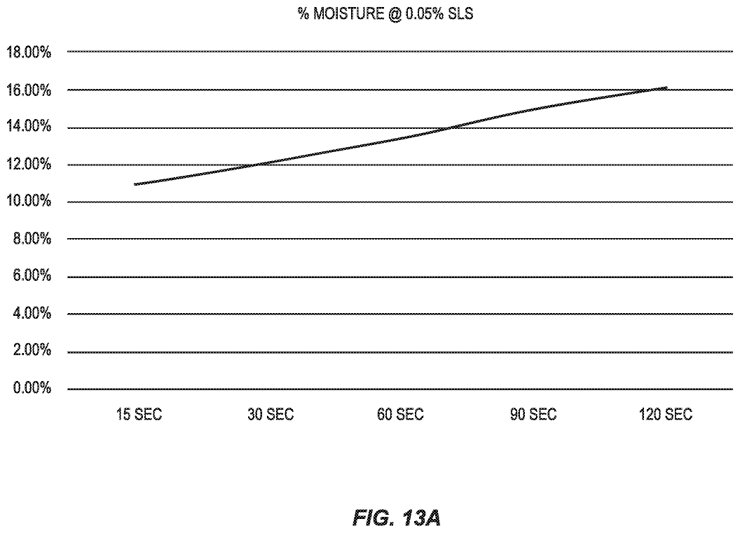

In an example, an initial packaging material 151, 153, 155 (e.g., paperboard, such as 18-point solid bleached sulfate board (SBS) with a PET barrier layer) was moisturized (e.g., in a water bath) to compare water as a moisturizing liquid to water-based moisturizing liquids having different amounts of a surfactant (e.g., SLS originally in powder form dissolved in the water). As shown in FIG. 13, the compared moisturizing liquids include water, water with 0.05% by weight of SLS, water with 0.1% by weight of SLS, water with 0.25% by weight of SLS, and water with 0.5% by weight of SLS. FIG. 13 and Table A, included below, show the amount of liquid uptake by the paperboard material (vertical axis) for dwell times from 0 seconds to about 120 seconds (horizontal axis). In the present example, the moisturizing liquid with surfactant, particularly with 0.25% by weight and 0.5% by weight of SLS in the moisturizing liquid, showed an increase (e.g., a significant increase) in the amount of the moisturizing liquid absorbed into the paperboard and an increase in the rate of moisturization. Another chart is shown in FIG. 13A with the data for 0.05 weight percent of SLS in water as the moisturizing liquid. In embodiments, additional surfactant can be included in the moisturizing liquid, which may provide even higher levels of moisturization of the manufactured paperboard of the initial packaging material (e.g., by weight percent) and/or higher rates of absorption. For example, the moisturizing liquid could include more than 0.5% by weight of SLS, such as 2% by weight or more of SLS in the water.

TABLE A
SLS Surfactant Moisture Gain in 18-Point SBS Paperboard

| Soak | | | | | |
|---|---|---|---|---|---|
| Time | H₂0 only | 0.05% SLS | 0.1% SLS | 0.25% SLS | 0.5% SLS |
| 0 | 6.2% | 6.2% | 6.2% | 5.9% | 6.2% |
| 15 | 9.4% | 11.0% | 12.7% | 22.1% | 45.6% |
| 30 | 11.0% | 12.1% | 14.1% | 27.7% | 51.4% |
| 60 | 12.3% | 13.4% | 15.6% | 42.0% | 54.2% |
| 90 | 12.6% | 15.0% | 18.0% | 48.4% | 55.2% |
| 120 | 14.5% | 16.2% | 19.7% | 49.8% | 55.4% |

While the packaging material and the surfactant used in the above example were 18-point SBS paperboard and SLS, respectively, any suitable paperboard and/or surfactant(s) could be used without departing from the disclosure. For example, the paperboard could have any suitable thickness and/or could have different coatings and/or laminated layers or could be uncoated and/or unlaminated.

In embodiments, the use of surfactant(s) (e.g., SLS and/or another suitable surfactant) can help increase uptake of water/moisturizing liquid relative to standard water (e.g., moisturizing fluids without surfactants). The increased moisturization of the paperboard (e.g., when the moisturizing liquid includes water and at least 0.25% SLS by weight or any other suitable amount of surfactant(s)) can increase the lubricity and/or malleability of the paperboard, which can facilitate increased processing and forming success during press-forming of bowls, trays, and/or other suitable constructs. For example, initial paperboard manufacturing material that is finished and manufactured paperboard with increased moisturization may be less likely to tear and/or experience other failures, such as due to decreased (tighter) tooling tolerances, than paperboard with less moisturization or no moisturization.

In examples, the paperboard blanks or treated webs W′ that have increased moisturization due to use of surfactants (e.g., greater than about 10% by weight moisture uptake, greater than about 15% by weight moisture uptake, greater than about 20% by weight moisture uptake, greater than about 25% by weight moisture uptake, greater than about 30% by weight moisture uptake, etc.) can have increased malleability that can allow the paperboard to be formed into shapes and/or features that are difficult or impossible without surfactants and/or high levels of moisturization. In embodiments, the increased malleability of the paperboard can allow for tighter tooling designs with sharper corners, steeper sides, multiple compartments, etc. that would likely lead to rupture, tearing, and/or other failure modes in paperboard without surfactants and/or high levels of moisturization.

In embodiments, the increased moisturization (e.g., utilizing a moisturizing liquid with surfactants) can lead to an increased level of lubricity and/or malleability of the highly moisturized paperboard/treated web W′, and the increased lubricity and/or malleability can allow for increased (e.g., significantly increased) process and forming success of press-forming constructs. For example, the moisturized paperboard can tear less often and/or can experience fewer failures due to decreased tooling tolerances (tighter tooling tolerances). Further, in embodiments, the surfactant may act as a lubricant in the tooling (e.g., the press-forming tool), wherein the lubrication may provide some resistance to sticking as the tooling is opened and/or closed and may allow the surfaces of the tooling to move against each other with reduced or no sticking and/or adhering. In exemplary embodiments, the surfactant may increase and/or improve the malleability, movement, stretching, and/or flexibility of the fibers of the paperboard material, which may increase the amount of draw and stretch during forming/pressing of the moisturized paperboard into a construct with reduced or eliminated breaking and/or snapping of the fibers and/or with reduced or eliminated tearing of the paperboard. In exemplary embodiments, the high moisturization of paperboard utilizing surfactants can allow for tighter tooling designs, which can include sharper corners, steeper sides, multiple compartments, and/or other suitable shapes and/or features that would be difficult or impossible for paperboard moisturized with only water (e.g., having a low moisturization level).

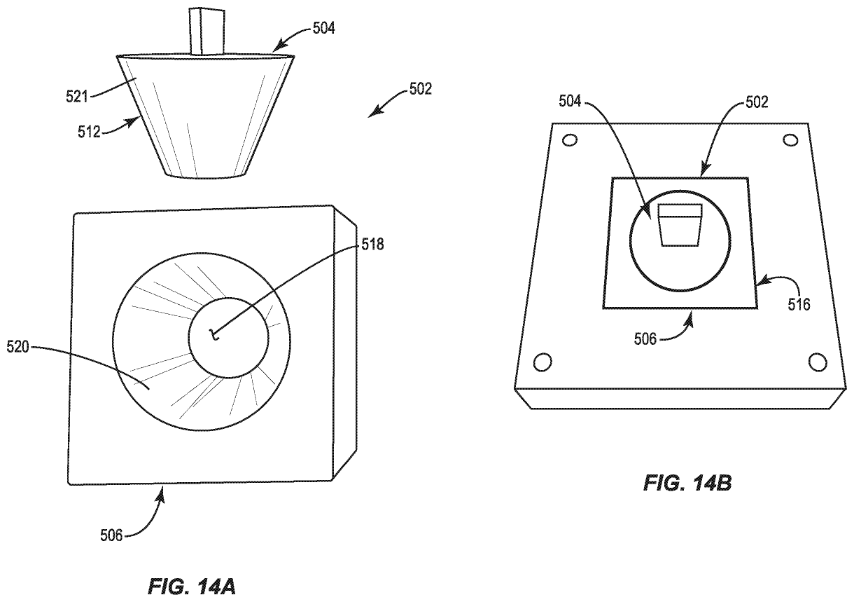

As shown in FIGS. 14A-16B, exemplary tools of additional embodiments of the disclosure can be used to form construct shapes that would be difficult or impossible in packaging materials without the malleability and/or flexibility of the highly moisturized paperboard such as the treated web W′. In embodiments, the exemplary tooling can be configured to test the malleability of the highly moisturized paperboard (e.g., utilizing moisturizing liquid containing surfactants), and the tooling can be configured with particularly steep walls, sharp corners, divider structures, and/or other features. The additional embodiments are generally similar to the prior embodiments, except for variations noted and variations that will be apparent to one of ordinary skill in the art. For example, as shown in FIG. 14A, a first tool configuration 502 can include a first or top part 504 and a second or base part 506 opposite to the top part 504. In the illustrated embodiments, the top part 504 can at least partially define a protrusion or punch 512, and the base part 506 can at least partially define a cavity 518 extending along an interior surface 520 of the base part 506. In the illustrated embodiments, the cavity 518 and the punch 512 can be complementary shapes so that the punch 512 is at least partially received in the cavity 518 when the top part 504 and the base part 506 are brought together to press the packaging material into the corresponding shape of the construct. For example, as shown in FIG. 14A, the punch 512 and the cavity 518 can have a complementary shape that is a tapered cylinders (e.g., partial cones), wherein the bottom has a smaller diameter than the top. Alternatively, the punch 512 and the cavity 518 can have any suitable complementary shape for forming any suitable construct or container without departing from the disclosure. As shown in FIG. 14A, the frustoconical shapes of the cavity 518 and the punch 512 have steep sides and an abrupt corner transition between the bottom and the sides. As noted above, such a shape could result in a higher rate of failure in forming constructs (e.g., the paperboard tears, ruptures, etc. when formed) when the paperboard has lower moisturization (e.g., about 10% moisturizing liquid by weight) than when press-forming constructs from highly moisturized paperboard (e.g., higher than about 20% moisturizing liquid by weight).

As shown in FIG. 14B, the base part 506 can be at least partially received in a support structure 516, which can hold the base part 506 while the top part 504 is moved toward the base part 506 and/or the bottom port 506 is moved toward the top part 504, moving the punch 512 at least partially into the cavity 518 to form the construct between the interior surface 520 of the base part 506 and an exterior surface 521 of the punch 512. The top part 504, the base part 506, and/or the support structure 516 could be otherwise shaped, arranged, positioned, and/or configured without departing from the disclosure.

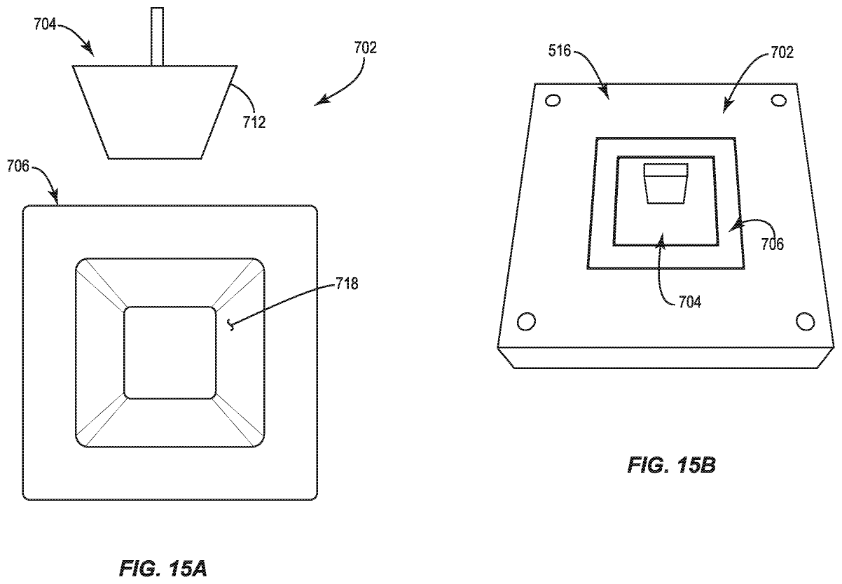

As shown in FIG. 15A, a second tool configuration 702 can include a first or top part 704 and a second or base part 706 having a respective punch 712 and cavity 718. In the illustrated embodiments, the punch 712 and the cavity 718 each can have a rectangular (e.g., square) cross-section and can have tapered sides (e.g., so that the bottoms are smaller than the respective tops). In one embodiment, the punch 712 and the cavity 718 can have a complementary shape that is a tapered rectangular prism/inverted truncated pyramid that is suitable for forming a correspondingly shaped construct. As shown in FIGS. 15A and 15B, the punch 712 and the cavity 718 can have sharper corners (e.g., a rounded corner with smaller radius of curvature) for highly moisturized paperboard as described above than would be used for paperboard with low moisture content or no moisture in order to avoid failure of the low moisture paperboard during and/or after press-forming. The second tool configuration 702 can be held in the support structure 516 as shown in FIG. 15B. The top part 704 and/or the base part 706 could be otherwise shaped, arranged, positioned, and/or configured without departing from the disclosure.

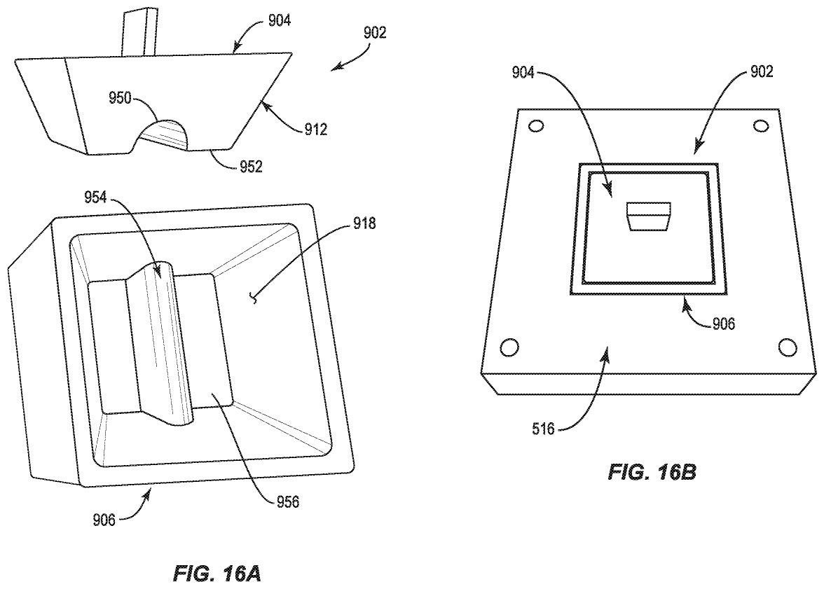

As shown in FIG. 16A, a third tool configuration 902 can include a first or top part 904 and a second or base part 906 having a respective punch 912 and cavity 918. In the illustrated embodiments, the punch 912 and the cavity 918 each can have a rectangular cross-section and can have tapered sides (e.g., so that the bottoms are smaller than the respective tops) similar to the embodiment of FIGS. 15A and 15B. As shown in FIG. 16A, the punch 912 and the cavity 918 can have complementary shape and features for forming a divider in a construct (not shown) formed from the tool. For example, the punch 912 can include a recess 950 extending along a bottom face 952 of the punch 912, and the base part can include a protrusion 954 (e.g., with a U-shaped cross-section) extending from the bottom surface 956 of the cavity 918. In embodiments, the protrusion 954 is sized to fit at least partially in the recess 950 for pressing a portion of the packaging material into a divider shape between the outer surface of the protrusion 954 and the inner surface of the recess 950. Similar to the embodiments of FIGS. 14A and 15A, the sharp corners and steep sides of the overall shape of the punch 912 and the cavity 918 and of the divider-forming features of the tool can be difficult to form with paperboard having a low moisture content or no moisture content, which is more likely to fail (tear, rupture, etc.). However, the highly moisturized paperboard (e.g., formed using a moisturizing liquid with surfactants as described above) can be press-formed with the tool 902 with fewer or no failures. The third tool configuration 902 can be held in the support structure 516 as shown in FIG. 16B. The third tool configuration 902 includes a punch 912 and cavity 918 having a complementary shape that is a tapered rectangular prism/inverted truncated pyramid with divider wall, so as to form the correspondingly shaped construct having a divider. The top part 904 and/or the base part 906 could be otherwise shaped, arranged, positioned, and/or configured without departing from the disclosure.

The tool configurations 502, 702, 902 are included by way of example to illustrate some of the numerous tool configurations for forming numerous constructs with shapes and/or features that are possible when processing paperboard with higher moisturization (e.g., utilizing moisturizing liquid with surfactants) and that would be more difficult or impossible for paperboard with lower moisturization. These tool configurations can include additional features, such as the exhaust features described in the prior embodiments above.

The webs and blanks according to the present disclosure can be, for example, formed from uncoated and/or coated paperboard and similar materials. For example, the interior and/or exterior sides of the webs and blanks can be coated with a clay coating. The clay coating may then be printed over with product, advertising, price coding, and other information or images. The webs and blanks may then be coated with a varnish to protect any information printed on the web and blank. The webs and blanks may also be coated with, for example, a moisture barrier layer, on either or both sides of the web and blank. In accordance with the above-described embodiments, the web and blanks may be constructed of paperboard of a caliper such that it is heavier and more rigid than ordinary paper. The web and blanks can also be constructed of other materials, such as cardboard, hard paper, or any other material having properties suitable for enabling the web, blank, construct, or packaging to function at least generally as described herein. The web or blanks can also be laminated or coated with one or more sheet-like materials at selected panels or panel sections.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method of press-forming a construct, the method comprising:
obtaining a forming tool comprising at least a punch and a cavity part, wherein the cavity part at least partially defines a cavity and comprises a plurality of ports in fluid communication with the cavity;
obtaining an initial paperboard packaging material, the initial paperboard packing material is a finished and manufactured solid bleach sulfate paperboard material;
feeding the initial paperboard packaging material to a treatment station and moisturizing the initial paperboard packaging material to form a moisturized paperboard packaging material by applying a moisturizing liquid with a surfactant to the initial paperboard packaging material;
positioning the moisturized paperboard packaging material between the punch and the cavity;
press-forming the moisturized paperboard packaging material into the construct by moving the punch and the cavity part together so that the punch is at least partially received in the cavity with the moisturized paperboard packaging material pressed therebetween; and
removing moisturizing fluid in the cavity released by the moisturized paperboard packaging material during press-forming via the plurality of ports in the cavity part.

2. The method of claim 1, wherein the surfactant acts as a wetting agent and accelerates the process of moisturizing the initial paperboard packaging material.

3. The method of claim 2, wherein the surfactant comprises is at least one of hydroxypropyl cellulose, polysorbate 60, gum arabic, and sodium lauryl sulfate.

4. The method of claim 2, wherein the moisturizing liquid is water.

5. The method of claim 1, wherein the moisturized paperboard packaging material includes at least 20% by weight of a moisturizing liquid prior to the press-forming the moisturized paperboard packaging material.

6. The method of claim 5, wherein the moisturized paperboard has increased malleability compared to initial paperboard packaging material.

7. The method of claim 1, wherein the forming tool further comprises a bottom assembly, the bottom assembly comprises the cavity part and a bottom mounting plate, the forming tool further comprising a top assembly comprising the punch.

8. The method of claim 7, wherein the bottom mounting plate comprises one or more output passageways that are in fluid communication with one or more of the ports of the plurality of ports, and wherein the removing moisturizing fluid comprises moving the moisturizing fluid through the one or more output passageways away from the cavity part.

9. The method of claim 7, wherein the cavity part defines a bottom recess extending along the bottom mounting plate, the bottom recess being in fluid communication with the ports of the plurality of ports, the bottom recess of the cavity part is in fluid communication with the one or more output passageways via a plurality of openings in the bottom mounting plate.

10. The method of claim 7, wherein the punch and the cavity include a complimentary shape to form the moisturized paperboard material into the construct having the complimentary shape.

11. The method of claim 10, wherein the complementary shape is a tapered cylinder.

12. The method of claim 10, wherein the complimentary shape is a truncated rectangular prism.

13. The method of claim 10, wherein the complimentary shape includes features for forming a divider wall in the construct.

14. A system for press-forming a construct, the system comprising:
a treatment station for moisturizing an initial paperboard packaging material, the initial paperboard packaging material is a finished and manufactured solid bleached sulfate paperboard material, the treatment station includes a moisturizing liquid with a surfactant and is for forming a moisturized paperboard packaging material by adding the moisturizing liquid with the surfactant to the initial paperboard packaging material; and
a forming tool comprising at least a punch and a cavity part, wherein the cavity part at least partially defines a cavity and comprises a plurality of ports in fluid communication with the cavity,
wherein the punch is for being at least partially received in the cavity for press-forming the moisturized paperboard packaging material into the construct between the punch and an interior surface of the cavity, and wherein the plurality of ports are for removing moisturizing fluid in the cavity released by the moisturized paperboard packaging material during press-forming.

15. The system of claim 14, wherein the surfactant comprises is at least one of hydroxypropyl cellulose, polysorbate 60, gum arabic, and sodium lauryl sulfate.

16. The system of claim 15, wherein the moisturizing liquid is water.

17. The system of claim 16, wherein the moisturized paperboard packaging material includes at least 20% by weight of a moisturizing liquid prior to the press-forming the moisturized paperboard packaging material.

18. The system of claim 14, wherein the forming tool further comprises a bottom assembly, the bottom assembly comprises the cavity part and a bottom mounting plate, the forming tool further comprising a top assembly comprising the punch.

19. The system of claim 18, wherein the bottom mounting plate comprises one or more output passageways that are in fluid communication with one or more of the ports of the plurality of ports, and wherein the removing moisturizing fluid comprises moving the moisturizing fluid through the one or more output passageways away from the cavity part.

20. The system of claim 18, wherein the cavity part defines a bottom recess extending along the bottom mounting plate, the bottom recess being in fluid communication with the ports of the plurality of ports, the bottom recess of the cavity part is in fluid communication with the one or more output passageways via a plurality of openings in the bottom mounting plate.

21. The system of claim 18, wherein the punch and the cavity include a complimentary shape to form the moisturized paperboard material into the construct having the complimentary shape.

22. The system of claim 21, wherein the complementary shape is a tapered cylinder.

23. The system of claim 21, wherein the complimentary shape is a truncated rectangular prism.

24. The system of claim 21, wherein the complimentary shape includes features for forming a divider wall in the construct.
